(19) United States
(12) Patent Application Publication
(10) Pub. No.: US 2020/0164563 A1
(43) Pub. Date: May 28, 2020

(54) METHOD OF BLOW MOULDING, FILLING AND CLOSING, AND CONTAINER PRODUCT, ESPECIALLY AMPOULE PRODUCT, PRODUCED THEREBY

(71) Applicant: KOCHER-PLASTIK MASCHINENBAU GMBH, Sulzbach-Laufen (DE)

(72) Inventors: Michael SPALLEK, Ingelheim (DE); Johannes GESER, Gerlingen (DE); Martin GROH, Gaildorf (DE)

(21) Appl. No.: 16/636,370

(22) PCT Filed: Aug. 3, 2018
(86) PCT No.: PCT/EP2018/071140

§ 371 Date: Feb. 4, 2020

(30) Foreign Application Priority Data
Aug. 5, 2017 (DE) 10 2017 007 443.7

(51) Int. Cl. B29C 49/00; A61J 1/06; B65D 1/09

(52) U.S. Cl. CPC B29C 49/0005; B29K 2067/003; B65D 1/09; A61J 1/067

(57) ABSTRACT

A blow molding, filling and closing process and container product produced accordingly, in particular an ampoule product.

A blow molding, filling and closing process for producing a filled and closed container product that can be stored as well, in particular in the form of an ampoule product which is formed from a plastic material and has a single-layer container wall or ampoule wall and which, during initial use, permits the withdrawal, in particular for an oral use of the product content, by opening at least one withdrawal opening for withdrawal purposes, is characterized in that plastic materials suitable for the process are selected which are tasteless and/or odorless or essentially tasteless and/or odorless in interaction with the contents of the container before and during use and which retain this tastelessness and/or odorlessness even after prolonged storage.

The invention relates to a blow molding, filling and closing process for the manufacture of a filled and sealed container product that can be stored as well, in particular in the form of an ampoule product, which is made of a plastic material and has a single-layer container wall or ampoule wall and which is integrally formed before initial use and which permits the withdrawal of the product contents, in particular for oral ingestion, when at least one withdrawal opening is opened during initial use.

DE 10 2008 006 073 A1 shows a so-called blow molding, filling and sealing process (BFS process), which is marketed worldwide and is known to experts as “Bottelpack®” (brand name). This process is particularly suitable for the manufacture of filled containers for medical purposes, including ampoules as containers for eye drops having filling volumes of 0.1 ml to 10 ml, for instance, and for ampoules for parenterally or orally administered liquids in the volume range of typically 0.5 ml to 50 ml. Typical cycle rates for the manufacture of filled and sealed BFS products are in the range of approx. 15 seconds and less.

Drinking ampoules made of low-density polyethylene as a plastic material using the BFS process are known from EP 2 269 558 B1. The well-known plastic ampoule has a body section, a mouth section, which forms an upper part of the body section, and a head section, which is continuously formed with the mouth section via a severable section. The upper part of this mouth section has a diameter, which is reduced further than that of the mouth section to form a shoulder section, wherein the upper end of this shoulder section extends along the separable section to the lower end of the head section.

In addition to low-density polyethylene as a plastic material, which is also technically referred to as LDPE, further plastic materials suitable for BFS processes are polyolefins and high-density polyethylene plastic materials, which are technically abbreviated HDPE, also polypropylene can be used as well as their blends and copolymers. In all these plastic containers and ampoule products, the contents of the ampoule only come into contact with a polymer material.

When using the aforementioned and known plastic materials in the context of BFS manufacturing processes, however, organoleptic impairments, i.e. impairments of taste and/or odor of the contents, which are generally also referred to as plastic taste, can occur, especially when sensitive products such as water are filled therein. In addition to the very unfavorable (i.e. low) ratio of filling volume to inner plastic surface, particularly in the case of ampoules in comparison to bottle products, another explanation could be in that in the BFS manufacturing process, the extruded, still hot polymer hose is cut by a hot knife immediately before it is filled and that the product is filled into the still hot polymer product immediately afterwards, within a few seconds, i.e. an organoleptic change in the product can easily occur at that stage. This might explain why the organoleptic impairment usually increases with increasing extrusion temperature of the plastic typically used. In the BFS manufacturing process, as described in DE 10 2008 006073 A1 mentioned above, but also in the U.S. Pat. No. 5,897,008, there are generally no finished empty containers for receiving the product that can be cleaned or ventilated sufficiently long to prevent the inadvertent transfer of taste, as is the case with other filling processes, such as those used for the manufacture of commercially available plastic beverage bottles, which can be classified as blow-molding processes, such as stretch blow-molding or injection-stretch blow-molding.

In particular in the case of the manufacture of BFS ampoules, which typically represent containers having filling volumes of less than 50 ml, the difference to the bottle products produced for the BFS process is even more pronounced, because ampoules are regularly vacuum-formed using the BFS manufacturing process and are not actually blow-formed.

To counter the undesired permeation of substances into and/or out of the filled container, EP 1 616 549 B1 describes a process for the manufacture of a plastic ampoule for a liquid drug, which comprises the steps below: Shaping a container body by holding a tubular co-extruded blow blank between lower divided mold parts and forming a cavity in the blow blank, wherein the blow blank has to comprise at least two layers, at least one functional layer of which is provided with at least one technical property: These include, for instance, the capability to prevent gas permeation, the capability to prevent vapor permeation, the capability to prevent drug permeation and the capability to prevent drug absorption/adsorption; as such, BFS ampoules of such multi-layer structure do not improve organoleptic neutrality, because BFS polyolefins are also used in this process and organoleptically questionable substances can be introduced via the gaseous phase, for instance via the opening of the container before it is filled.

On the basis of this state of the art, the invention addresses the problem of preventing any adverse effects on the product content, in particular in the form of adverse organoleptic effects, for container products manufactured by blow molding, filling and closing, in particular ampoule products.

A process having the features of patent claim 1 in its entirety and a container product manufactured in accordance with the features of patent claim 8 solve this problem. Further advantageous embodiments of the solution according to the invention are the subject of the dependent claims.

By selecting plastic materials suitable for the BFS method in accordance with the characterizing part of patent claim 1, which are organoleptically neutral or essentially organoleptically neutral in their interaction with the contents of the container before and during use, in particular in the case of oral ingestion, and which retain this neutrality even after prolonged storage, it is ensured that the plastic material used for the manufacturing method do not adversely organoleptically affect the contents of the product or the product contents. In particular, there is at least a minimization of the adverse effects on taste also in the case of aqueous products, i.e. even trained taste testers cannot detect the so-called plastic taste to a relevant extent. The “plastic taste” in this case also includes the sensory test for plastic odor, which the trained taste testers likewise were unable to detect at all or only to a small extent.

It has proved to be particularly advantageous to use selected aromatic polyester polymers as plastic materials for the manufacture of a single-layer, filled, sealed ampoule product that is integral at least until it is used. Even if filled and sealed containers and ampoules are stored for longer periods of time, their neutral taste is largely retained. For an average expert in the field of BFS technology, it is surprising that the use of selected aromatic polyester polymers prevents mass transfer from the plastic material to the stored product including the impairment of the organoleptic properties, although, in contrast to known manufacturing processes such as stretch blow molding, the BFS process does not result in a permeation-reducing orientation, i.e. stretching of polymer chains, in the manufacturing process.

Although the melting and extrusion temperatures for the aromatic polyester polymers to be used according to the invention are between 250° C. and 280° C., which is significantly higher than the processing temperatures of commonly used BFS polyolefins, which are typically in the range of 160° C. to 210° C., a reduced organoleptic impairment results, contributed to by the relatively high intrinsic material viscosities (between 0.6 dl/g and 1.7 dl/g measured based on ASTM D4603) of the aromatic polyesters according to the invention.

Moreover, it has proven to be very advantageous to select values of below 50 ppm, preferably below 30 ppm, for the water content of the plastic granulate of specifically selected aromatic polyester polymers to be used in the FSO manufacture process immediately before extrusion. In particular, the organoleptic changes during the storage period of the filled and sealed container are minimized.

Another advantage of the BFS process according to the invention is its environmental performance, because reclaimed material at ratios of 10% to 80%, preferably 30% to 60% can be added to the aromatic polyester polymers used.

According to the invention, the specific aromatic polyester polymers listed below can be used for the BFS process:
polyethylene naphthalate (PEN),
polybutylene terephthalate (PBT), but preferably
polyethylene terephthalate (PET) or its copolyesters and blends, and
glycol-modified polyethylene terephthalate (PETG), and
polyethylene furanoate (PEF)
copolyesters manufactured using terephthalic acid
and in each case the copolymers and/or blends thereof.

It is also advantageous if the opening cross-section, which is exposed when a head part is removed from the remaining product body, thereby opening the withdrawal opening, is smaller than 25 mm², preferably smaller than 10 mm². In this respect, it may also assumed that this reduced cross-section contributes to the fact that only very few organoleptically questionable substances, if any, can penetrate the product or the gas space of the ampoule.

For ease of handling in particular, it is also advantageous to design the ampoules in such a way that the average wall thickness in the region of the product body intended to contain the product is 0.2 mm to 0.9 mm, preferably 0.4 mm to 0.6 mm, and that the average wall thickness at and in the region of the point of separation or predetermined breaking point, forming the respective opening cross-section, is smaller than 0.5 mm, preferably smaller than 0.3 mm.

Furthermore, the use of the aromatic polyester polymers used results in an advantageous manner in a product wall having a high degree of transparency which permits the product content to be visually examined without a physical change by stretching the polymer chains taking place in the course of the BFS process—as explained above.

The high transparency of the ampoule products manufactured according to the invention facilitates the inspection of their contents for changes such as turbidity or impurities. In the case of classic BFS polyolefins such as polypropylene, this can only be achieved by using additives in the plastic material to increase transparency and only to a limited degree at that. Such additives, which are technically referred to as “clarifiers”, are disadvantageous in medical applications, however, because their constituents can easily pass into the contents of the containers, which in most cases does not meet the organoleptic and/or medical requirements.

Below, the procedure according to the invention is explained in more detail using various ampoule products based on the drawing. In the figures, in general view, not to scale,

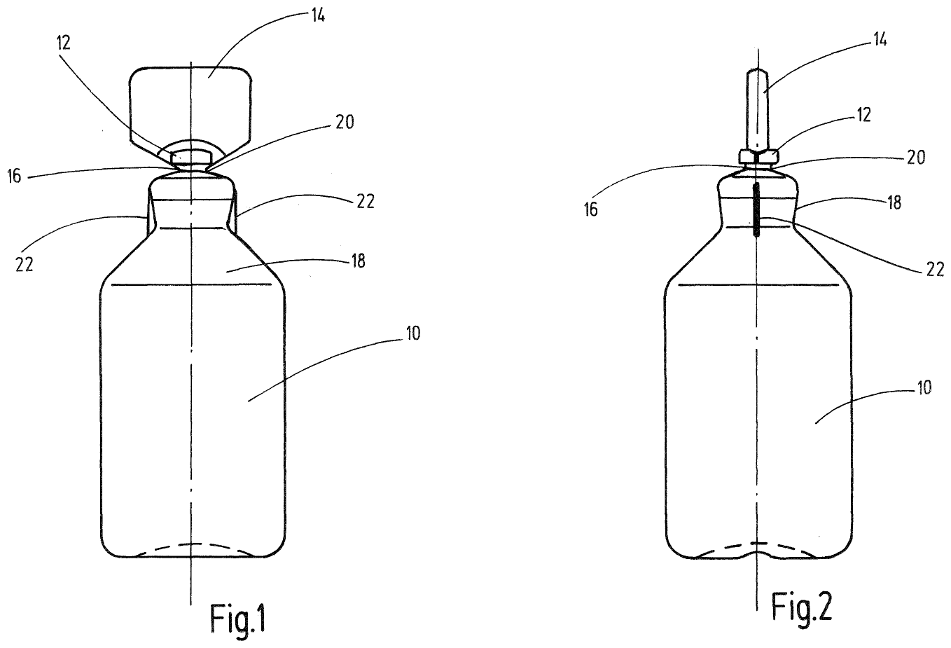

FIG. 1 shows a lateral top view of an ampoule product;

FIG. 2 shows a lateral view of the ampoule product of FIG. 1, which is rotated by 90° around its longitudinal or vertical axis;

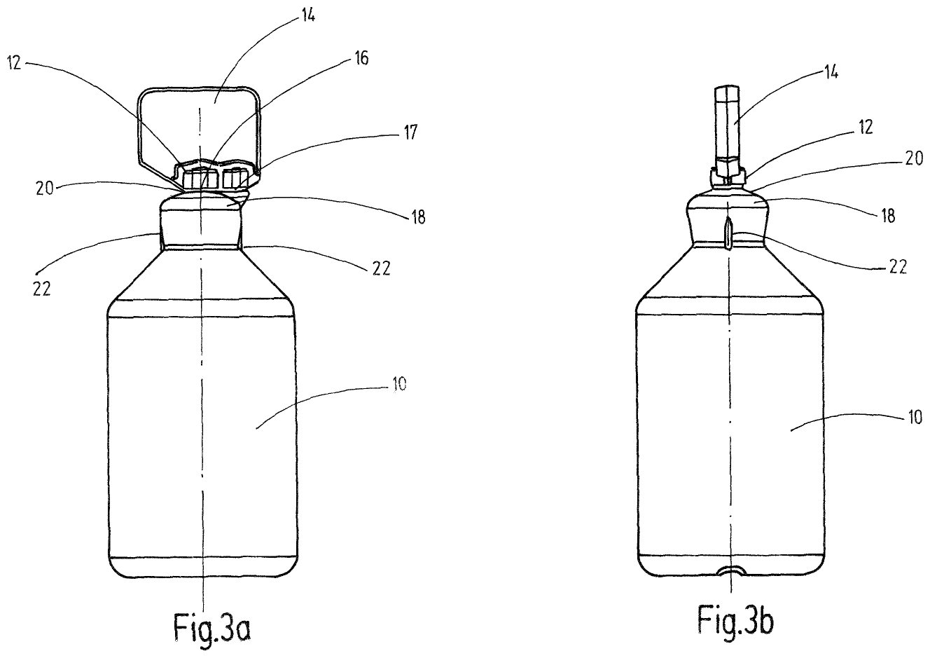

FIGS. 3a, 3b show an exemplary embodiment of an ampoule product having two discharge openings, one in end view, one in side view;

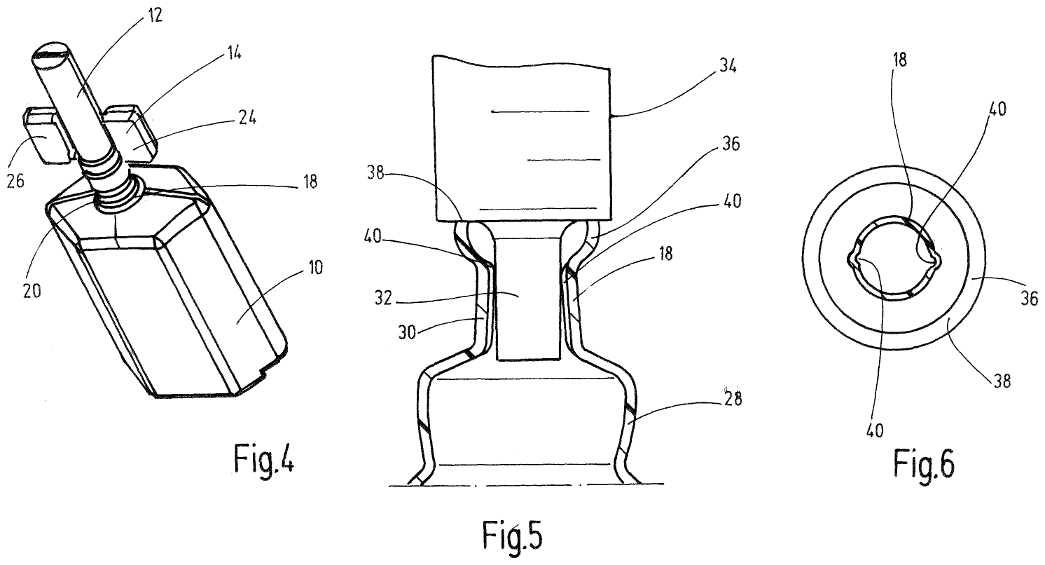

FIG. 4 shows a perspective view from above onto a further exemplary embodiment of an ampoule product;

FIG. 5 shows an enlarged and incomplete longitudinal section of another exemplary embodiment of an ampoule having a Luer-cone syringe inserted into the neck of the ampoule; and

FIG. 6 shows a correspondingly enlarged section along the line VI-VI of FIG. 5.

The ampoule product shown in FIGS. 1 and 2 is produced according to the Bottelpack® process, in which the ampoule product is vacuum-formed, filled and sealed in a workstation. As a rule, such ampoule products are manufactured in a so-called ampoule block, in which several containers are connected to each other in a row.

The ampoule shown in the figures has an ampoule or product body 10, in which a delivery medium of the ampoule is stored. In this case, the medium to be dispensed is a low-sodium, still mineral water to be able to detect potential changes in taste as easily as possible. The filling quantity of the medium to be dispensed in the product body 10 is approximately 10 ml. A well-known BFS machine of the type Bottelpack 321 by Rommelag was used to produce this 10 ml ampoule.

Furthermore, the ampoule has a head part 12, which the user can twist off the ampoule body 10 by means of a twist-cap 14, wherein on the upper side of the ampoule body 10 a withdrawal opening 16 can be opened to form an opening cross-section through which the ampoule contents can be withdrawn. As the figures further show, the otherwise cylindrical ampoule body 10 tapers in the direction of a neck part 18, which in the unopened state of the ampoule establishes a connection of the ampoule body 10 and the head part 12 with the twist-cap 14. In order to facilitate detaching the head part 12 using the twist-cap 14, a point of separation or predetermined breaking point 20 is inserted in the ampoule between the connection neck part 18 and the head part 12. Stiffener webs 22 can be used to stiffen the neck section 18, which stiffener webs are integrally formed during the Bottelpack® manufacturing process. This design of an ampoule is sufficiently known, accordingly no further details will be given here.

The aromatic polyesters listed below were used as plastic materials for the manufacture of the ampoule product of FIGS. 1 and 2, wherein any details of the manufacturer and/or trade name are given in brackets:
polyethylene terephthalate (Traytuf 9506, M&G Gruppo Mossi & Ghisolfi),
polyethylene terephthalate copolyester (Polyclear® EBM PET 5505, Invista),
polyethylene naphthalate-polyethylene terephthalate-Blend (Hipertuf 85032, Shell Chemicals),
polyethylene furanoate (PEF, Avantium),
copolyesters produced using terephthalic acid (Tritan copolyester MX810, Eastman),
polybutylene terephthalate (Pocan 1501, Lanxess),
polyethylene terephthalate glycol (Eastman MB002 and SK Chemicals S2008).

Using the aromatic polyester materials mentioned above, ampoules were obtained having glass-like transparency and a surface sheen, which can be inspected using automatic inspection equipment or by the human eye, far better than ampoules having the same geometry and wall thickness, which are made of the known materials polypropylene or low-density polyethylene (LDPE). An automatic inspection system is described for instance in DE 10 2014 006 835 A1 of the patentee.

The ampoule shown in FIGS. 1 and 2 is also suitable as a container for products that cannot be administered orally, enterally or nasally, such as eye drops, injection or inhalation solutions, suspensions and the like, for which regular inspection of the filled and sealed containers is important and sometimes even required by law.

Despite the “improved” mechanical properties (ISO 527-1-2) of the BFS polyester according to the invention having typically high tensile strengths of more than 80 MPa and high tensile coefficient of elasticity of more than 2000 MPa compared to the standard BFS polyolefins (LDPE, HDPE, PP), the ampoules according to the invention can be opened quite easily. Their opening torques are on average 40 Ncm to 55 Ncm, measured using a Vortex-i torque gauge by Mecmesin at a rotational speed of 20 rpm. Such torques can be easily applied by adolescents and adults, i.e. the invented ampoules are particularly suitable for single doses of oral, enteral, sublingual or topical preparations to be used for instance in the oral cavity, such as medications, medicinal products, food supplements, tonics, vitamins, homeopathic remedies, etc.

The rapid withdrawal of the product by squeezing it out, for instance to apply a solution or emulsion to the tongue, is considerably facilitated if the container can be vented via an additional opening. According to the invention, this can be achieved by opening at least two openings when the ampoule is opened.

FIGS. 3a and 3b show an exemplary embodiment of an ampoule having two withdrawal openings 16, 17, wherein the larger withdrawal opening 16, for instance, has a diameter of 2 mm, whereas the smaller opening 17 has a diameter of approx. 1 mm. The two withdrawal openings 16, 17 are opened simultaneously, provided that the head part 12 is twisted off the neck part 18 in the known manner by means of the twist-cap 14 via the assigned point of separation or predetermined breaking point from the other ampoule body or product body 10. This ampoule solution can also be provided with pairs of reinforcing webs 22. Except for the two withdrawal openings 16, 17 mentioned, the container according to FIGS. 3a and 3b largely resembles the solution according to FIGS. 1 and 2. The simultaneous opening of the ampoule body 10 via the predetermined breaking point, which can also be designed as a common predetermined breaking point 20, results in a faster emptying of the ampoule product due to the resulting improved ventilation because two withdrawal openings 16, 17 have been opened.

The metered withdrawal of the product, for instance squeezing out individual drops, is considerably facilitated if the ampoule body 10 does not have a largely circular cross-section, but preferably an oval, diamond-shaped or hexagonal cross-section. The ampoule body 10 of FIG. 4 has such a hexagonal cross-section 10. Also, in this ampoule version the head part 12 can be removed from the neck part 18 of the ampoule body 10 along the point of separation or predetermined breaking point 20 by means of the twist-cap 14, in this case having the form of two handles 24, 26. A syringe needle (not shown) can be inserted into and attached to the ampoule body 10 in a known manner, the end of which needle is then exposed for an application process after the head part 12 has been removed.

The withdrawal of the product, e.g. sucking it with the aid of a straw inserted through the withdrawal opening 16, is considerably facilitated if the container is vented during withdrawal. According to the invention this can be achieved by designing the withdrawal opening 16 in such a way that an opening cross-section results, which is not circular—for instance oval—and therefore cannot form a seal with the outer surface of the drinking straw.

The almost complete withdrawal of the product by means of the cone connection of a syringe, for instance for oral (non-Luer-6% connectors, oral tip, EN ISO 80369-3:2016) or dental (6% Luer cone in accordance with EN 1707:1996 and EN 20594-1:1993) applications, is also facilitated if the withdrawal opening 16 permits the container to be vented during withdrawal. According to the invention, this can be achieved by having the geometry of the withdrawal opening 16 deviate only slightly from that of the cone connection to be used. This can be achieved, for instance, by means of at least one longitudinal channel for ventilation, which, however, is just sufficiently small/deep to prevent liquid from escaping during overhead withdrawal. Preferably, at least one ventilation duct is located in the mold parting surface of the container and has a preferred duct cross-section corresponding to that of a rounded triangle.

Such an aeration chamber solution is shown in FIGS. 5 and 6. The end of the ampoule body 10 opposite the bottom adjoins a first section 28 of the neck part 18, the diameter of which is smaller than the preferably cylindrical diameter of the ampoule body 10 itself due to the conical taper of the ampoule body 10 at its top. This section 28 is followed by a smaller diameter cylindrical section 30, the inner diameter of which is slightly smaller than the largest diameter of the Luer cone 32 of a syringe 34, but slightly larger than the smallest diameter thereof. In this way, a closed, linear contact is achieved between the inserted Luer cone 32 and the inner wall of the neck part 18 in the area of section 30, namely along a cross-sectional plane, as it is shown in FIG. 6 by way of example, which prevents the passage of liquids, but permits the passage of air. In the present embodiment of an ampoule body 10, a protruding thickened rim-like section 36 adjoins section 30 of the neck section 18, the axial length of which rim-like section is selected such that the Luer cone 32 rests against the inner wall of the cylindrical section 30 of the neck section 18 at the required but relatively small contact pressure, which is necessary to prevent the passage of liquids when the end face of the syringe body 34 supporting the Luer cone 32 rests against the free end face 38 of the neck section 18. The syringe 34 docked to the ampoule body 10 preferably has a 9% Luer cone 32 as syringe end. Especially the ampoule product 10 according to FIGS. 1 and 2 as well as FIGS. 3a and 3b can be used similar to extracting the product contents using a suitable Luer cone syringe 34.

To improve the passage of air between the Luer cone 32 and the neck part 18 in the area of the further section 30, this section 30 is provided with a ventilation channel 40 in the form of an inwardly open longitudinal groove arranged at two points diametrically to the longitudinal axis of the ampoule product 10, the cross-section of which groove is preferably selected in the form of a rounded triangle (see FIG. 6) such that the air flowing in prevents liquid from escaping. Only one single ventilation duct 40 is required to achieve the desired ventilation; if necessary, the cross-section of the duct 40 can be increased accordingly. In case of one ventilation duct 40 only, the outer circumference of the Luer cone 32 rests off-center against the other wall parts of section 30 of the neck section 18. Furthermore, for manufacturing reasons, the ventilation channel 40, which extends in parallel to the longitudinal axis of the ampoule, is advantageously placed in the plane of the mold halves which, when brought together in this plane, permit the ampoule to be shaped.

In a further, unspecified embodiment of an ampoule made of plastic having a container part for receiving a predeterminable fluid, which container part is provided with a neck part, which can be closed off by a head part, and which has a channel-like entry point for air into the interior of the container part, it may also be provided for effective ventilation that said entry point for air consists of at least one annular channel, which is arranged at least partially on the outside and/or inside circumferential side of the neck part, which enables the container contents to be withdrawn more quickly by means of the syringe or cannula body.

If the ampoules are to be resealable, that can be achieved by introducing appropriate additional components before the ampoules are sealed. This is described in detail in DE 10 2007 007 474 B3 (Hansen) using a 2-part dropper insert by way of example.

The intrinsic viscosity of the aromatic polyester polymers used, measured based on ASTM D4603, is preferably in the range from 0.6 dl/g to 1.7 dl/g, and particularly preferably from 0.8 dl/g to 1.5 dl/g.

In the case of polyethylene terephthalate, polyethylene terephthalate-glycol and their blends and copolymers, an intrinsic viscosity of more than 0.8 dl/g is preferred.

Furthermore, it has been shown to be advantageous not to select a water content of more than 50 ppm for the granulate immediately prior to extrusion, in particular in the case of polyethylene terephthalate or polyethylene furanoate, and preferably to select a water content of less than 30 ppm.

The average wall thickness of the ampoule body 10 in the area of the point of separation or predetermined breaking point 20 shall be smaller than 0.45 mm, preferably smaller than 0.3 mm. The average wall thickness of the ampoule in the area of the ampoule body 10 shall be 0.2 mm to 0.9 mm, but preferably 0.3 mm to 0.7 mm. The ampoule shall have a small opening cross-section of less than 25 mm², preferably less than 10 mm².

If the criteria of the invention described above are met, a minimization of the organoleptic impairment is achieved for aqueous products, which is surprising because the melting and extrusion temperatures of the aromatic polyester polymers to be used according to the invention at 250° C. to 280° C. are significantly higher than the polyolefins usually used for the BFS manufacturing process, whose processing temperature is typically in the range from 160° C. to 210° C.

Another advantage of the ampoules according to the invention is the option of using recycled plastic material. 10 to 80%, preferably 30 to 60%, reclaimed material can be added to the original aromatic polyester polymer during manufacture.

To test the organoleptic properties, a sensory test was performed based on the standard DIN 10955:2004-06. The purpose of the test is to determine whether the BFS polymer used results in an altered smell or taste of the test substance in the form of still, low-sodium mineral water as part of the BFS manufacturing process described above. The test detects odor and aroma transfer, under defined conditions, from the test material either into the air space (odor test) or into the test substance (taste test). This analysis has shown that in using aromatic polyester materials as part of the BFS method only slight taste changes of the test water can be detected by the trained taste testers and that the ampoules made of aromatic polyester polymers were clearly superior to those made of known BFS polyolefins.

The use of polymers containing polyethylene furanoate is clearly advantageous over the use of the known polyethylene-based plastics. For instance, hot filling, which is preferred for microbiological reasons, or heat treatment of the sealed container to stabilize highly concentrated solutions that tend to crystallize are feasible options.

Exemplary embodiments of applications are listed below:

A Bottelpack 321 BFS machine by Rommelag, Waiblingen, Germany, was used. This machine was used to produce ampoules as shown in FIGS. 1, 3 and 4 having a container volume of approximately 10 ml; the ampoules were filled with 5-10 ml of still water low in minerals and taste. The still water was delivered in glass bottles. A PET by M&G Chemicals (Gruppo Mossi & Ghisolfi); type designation Traytuf 9506 was used as polymer material—cf. test number 1. Using a molecular sieve dryer by Digicolor, the granulate was dried to a water content of 36 ppm (mean value from 3 samples) for 10 hours at 120° C. and an air dew point of below minus 30° C. and conveyed to the extruder of the BFS line all the while being protected from moisture. The intrinsic viscosity of the dried polymer was measured based on ASTM D4603 and was found to be 0.94 dl/g. The extrusion temperature during ampoule manufacture was 252° C.; the melt pressure was 262 bar.

Similarly (cf. test numbers 2 et seqq.), ampoules of different geometries and filling quantities were manufactured from other polymers on different BFS lines. As a reference to the state of the art (cf. test numbers Ref a-c), polystyrene (PS) and, by way of example, the two BFS polyolefins, polypropylene (Purell RP 270G by LyondellBasell) and low-density polyethylene, LDPE (Purell 3020D by LyondellBasell), were used.

The details of all tests are summarized in the table below.

| | | | | | | | | | Melt | | | |
|---|---|---|---|---|---|---|---|---|---|---|---|---|
| | | | | | | | | | volume | Mass | Mass | |
| | Ampoule | Fill | | | | | Residual | Intrinsic | rate | pres- | temper- | Organ- |
| Test | According | volume | | | | | moisture | viscosity | cm³/ | sure | ature | oleptic |
| No. | to Fig. | ml | polymer | type | manufacturer | desiccation | ppm | dl/g | 10 min | bar | ° C. | change |
| 1 | 1 | 10 | PET | Traytuf | M&G | 10 h at | 38 | 0.94 | n. a. | 262 | 252 | Very low |
| | | | | 9506 | Chemicals | 120° C. | | | | | | |
| 2 | 1 | 8 | PEF | PEF | Avantium | 18 h at | 34 | 0.88 | n. a. | 258 | 256 | Very low |
| | | | | | | 150° C. | | | | | | |
| 3 | 3 | 8 | PBT | Pocan | Lanxess | 6 h at | 95 | n. a. | 16* | 251 | 252 | low |
| | | | | B1501 | | 125° C. | | | | | | |
| 4 | 3 | 5 | PETG | MB002 | Eastman | 12 h at | 190 | 0.85 | n. a. | 237 | 220 | Very low |
| | | | | | | 60° C. | | | | | | |
| 5 | 4 | 10 | PETG | S2008 | SK | 6 h at | 300 | 1.2 | n. a. | 222 | 195 | Very low |
| | | | | | Chemicals | 55° C. | | | | | | |
| 6 | 4 | 5 | PET-Co- | MX810 | Eastman | 6 h at | 200 | 1.1 | n. a. | 260 | 205 | low |
| | | | polyester | | | 87° C. | | | | | | |
| 7 | 1 | 8 | PET-Co- | Poly- | Invista | 10 h at | 50 | 1.01 | n. a. | 285 | 251 | Very low |
| | | | polyester | clear | | 120° C. | | | | | | |
| | | | | 5505 | | | | | | | | |
| | | | | | | | | | Melt | | | |
| | | | | | | | | | flow rate | | | |
| | | | | | | | | | g/10 min | | | |
| Ref-a | 1 | 10 | LDPE | Purell | Lyondell- | none | n. a. | n. a. | 0.3** | 205 | 179 | high |
| | | | | 3020D | basell | | | | | | | |
| Ref-b | 3 | 10 | PP | RP270G | Lyondell- | none | n. a. | n. a. | 1.8*** | 200 | 186 | Very high |
| | | | | | basell | | | | | | | |
| | | | | | | | | | Melt | | | |
| | | | | | | | | | volume | | | |
| | | | | | | | | | rate | | | |
| | | | | | | | | | cm³/ | | | |
| | | | | | | | | | 10 min | | | |
| Ref-c | 4 | 10 | PS | PS 486N | Styrolution | none | n. a. | n. a. | 4**** | 91 | 189 | Very high |

*250° C/2.16 kg
**190° C/2.16 kg
***230° C/2.16 kg
****200° C/5 kg

An odor and aroma transfer test was performed based on the standard DIN 10955:2004-06. The purpose of the test was to determine whether the BFS polymer/process used resulted in a change in smell or taste of the test substance (low-sodium, still mineral water). The test detects odor and aroma transfer of agents, which under defined conditions, pass from the test material either into the air space (odor test) or via the air space or in case of direct contact pass into the test substance (taste test). The results, the organoleptic change with respect to the original water, are listed in the table above.

Surprisingly, the trained taste testers detected only slight taste changes of the test water for the aromatic polyester materials, and ampoules made of the materials PEF, PET and the co-polyester were clearly superior to those of the reference materials (PS, PP and LDPE).

1. A blow molding, filling and closing process for producing a filled and closed container product that can be stored as well, in particular in the form of an ampoule product which is formed from a plastic material and has a single-layer container wall or ampoule wall and which, during initial use, permits the withdrawal, in particular for an oral use of the product content, by opening at least one withdrawal opening for withdrawal purposes, characterized in that plastic materials suitable for the process are selected which are tasteless and/or odorless or essentially tasteless and/or odorless in interaction with the contents of the container before and during use and which retain this tastelessness and/or odorlessness even after prolonged storage.

2. The process according to claim 1, characterized in that aromatic polyester polymers and/or polyester copolymers and/or blends of these materials are used as plastic materials for the products to be produced.

3. The process according to claim 1, characterized in that temperatures in the range from 250° C. to 280° C. can be selected as processing temperatures for the aromatic polyester polymers and their intrinsic viscosities during processing can be selected to be 0.6 dl/g to 1.7 dl/g.

4. The process according to claim 1, characterized in that the water content of the plastic granulate in the manufacturing process for specifically selected aromatic polyester polymers and/or copolymers immediately prior to extrusion is selected to be less than 50 ppm, preferably 30 ppm.

5. The process according to claim 1, characterized in that 10% to 80%, preferably 30% to 60% reclaimed material is added to the aromatic polyester polymers used.

6. The process according to claim 1, characterized in that at least partially a
polyethylene naphthalate (PEN),
polyethylene furanoate (PEF)
polyester and/or copolyester produced from terephthalic acid, in particular
polybutylene terephthalate (PBT), but preferably
polyethylene terephthalate (PET),
glycol-modified polyethylene terephthalate (PETG), and in each case any copolymers and/or blends thereof is used as relevant aromatic polyester polymer.

7. A container product, in particular ampoule product, produced by a blow molding, filling and closing process according to claim 1, characterized in that the product material is formed from at least one aromatic polyester polymer and/or polyester copolymer and/or polyester copolymer and/or blends at least partially containing these materials.

8. The product according to claim 7, characterized in that the receiving volume for the product to be received and stored, in particular in the form of a liquid, is less than 50 ml.

9. The product according to claim 7, characterized in that the opening cross-section of the relevant withdrawal opening (16), which is opened upon separation of a head part (12) from the remaining product body (10), is smaller than 25 mm2, preferably smaller than 10 mm2.

10. The product according to claim 7, characterized in that the shape of the withdrawal opening (16) deviates from the circular shape and preferably has an oval or polygonal geometry.

11. The product according to claim 7, characterized in that the product body (10) has a non-circular cross-section, preferably an oval or polygonal, particularly preferably a hexagonal cross-section.

12. The product according to claim 7, characterized in that the withdrawal opening (16) has at least one channel, which permits ventilation during the withdrawal of the product.

13. The product according to claim 12, characterized in that the withdrawal opening (16) has at least one channel (40), which is located in the mold parting surface.

14. The product according to claim 12, characterized in that the withdrawal opening (16) comprises at least one channel (40), preferably having a cross-section corresponding approximately to that of a rounded triangle.

15. The product according to claim 7, characterized in that the average wall thickness in the region of the product body (10) intended to contain the relevant product is 0.2 mm to 0.9 mm, preferably 0.3 mm to 0.7 mm, and that the average wall thickness at and in the region of the point of separation or predetermined breaking point (20) is smaller than 0.5 mm, preferably smaller than 0.3 mm.

16. The product according to claim 7, characterized in that the product wall has a high degree of transparency, which permits the product content to be examined visually.
